(19) United States
(12) Patent Application Publication
(10) Pub. No.: US 2014/0132813 A1
(43) Pub. Date: May 15, 2014

(54) CAMERA MODULE HAVING PASSIVE COMPONENTS

(71) Applicants: HONG FU JIN PRECISION INDUSTRY (ShenZhen) CO.,LTD., (US); HON HAI PRECISION INDUSTRY CO., LTD., New Taipei (TW)

(72) Inventors: WEI CHEN, Shenzhen (CN); TANG-HONG ZHANG, Shenzhen (CN)

(73) Assignees: HON HAI PRECISION INDUSTRY., LTD., New Taipei (TW); HONG FU JIN PRECISION INDUSTRY (ShenZhen) CO., LTD, Shenzhen (CN)

(21) Appl. No.: 13/859,715

(22) Filed: Apr. 9, 2013

(30) Foreign Application Priority Data
Nov. 14, 2012 (CN) 2012104560821

(51) Int. Cl. H04N 5/225

(52) U.S. Cl. CPC H04N 5/2254
USPC 348/308; 348/335; 348/302

(57) ABSTRACT

A camera module includes a substrate, an image sensor chip, a lens module and a number of passive components. The substrate includes a supporting surface. The image sensor chip is supported by the supporting surface, and electrically connected to the substrate. The lens module is positioned on the supporting surface with the image sensor chip being received in the lens module. The passive components are positioned on the supporting surface and mechanically and electrically connected to the substrate. The passive components are all located outside the lens module.

### BACKGROUND

1. Technical Field

The present disclosure relates to camera modules, and particularly to a camera module having passive components.

2. Description of Related Art

A camera module generally includes a substrate, an image sensor, and a plurality of passive components mounted to the substrate. In assembly, the image sensor is first physically and electrically connected to the substrate via a number of soldering pads positioned between the image sensor and the substrate, and then the passive components are substantially positioned at the same level with the imaging sensor, and surrounding the image sensor. In this step, dust and small particles may be generated by the passive components due to friction, and may fall on the image sensor. Accordingly, such contaminants may cause the image quality of the camera module to be unsatisfactory.

Therefore, it is desirable to provide a camera module which can overcome the above-mentioned limitations.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an assembled, isometric view of a camera module, according to an exemplary embodiment.

FIG. 2 is an exploded, isometric view of the camera module of FIG. 1.

### DETAILED DESCRIPTION

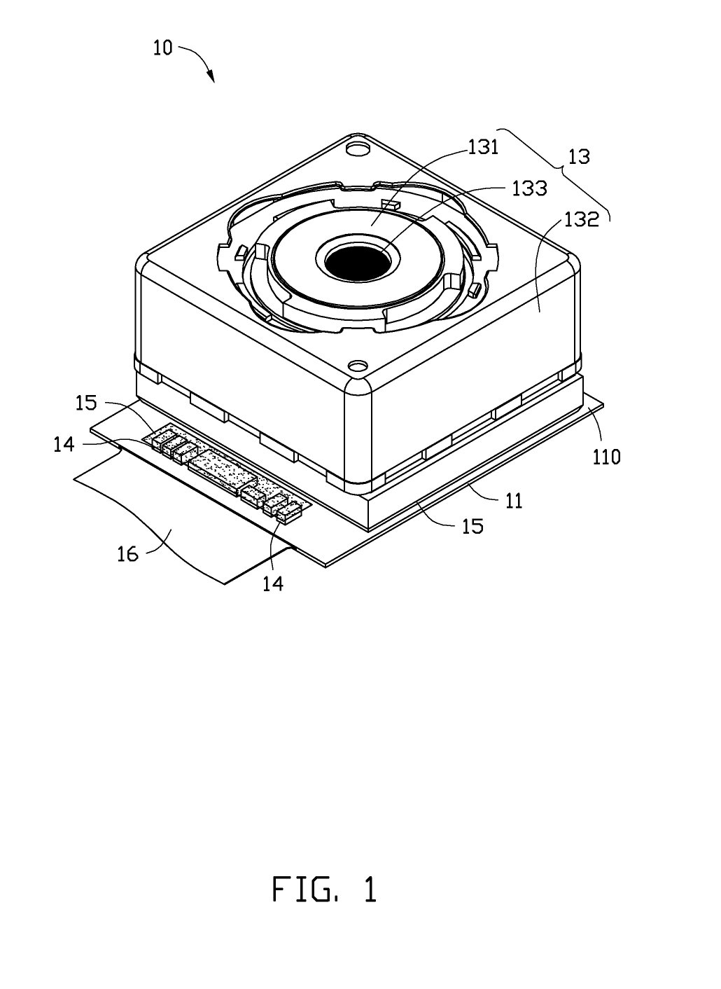

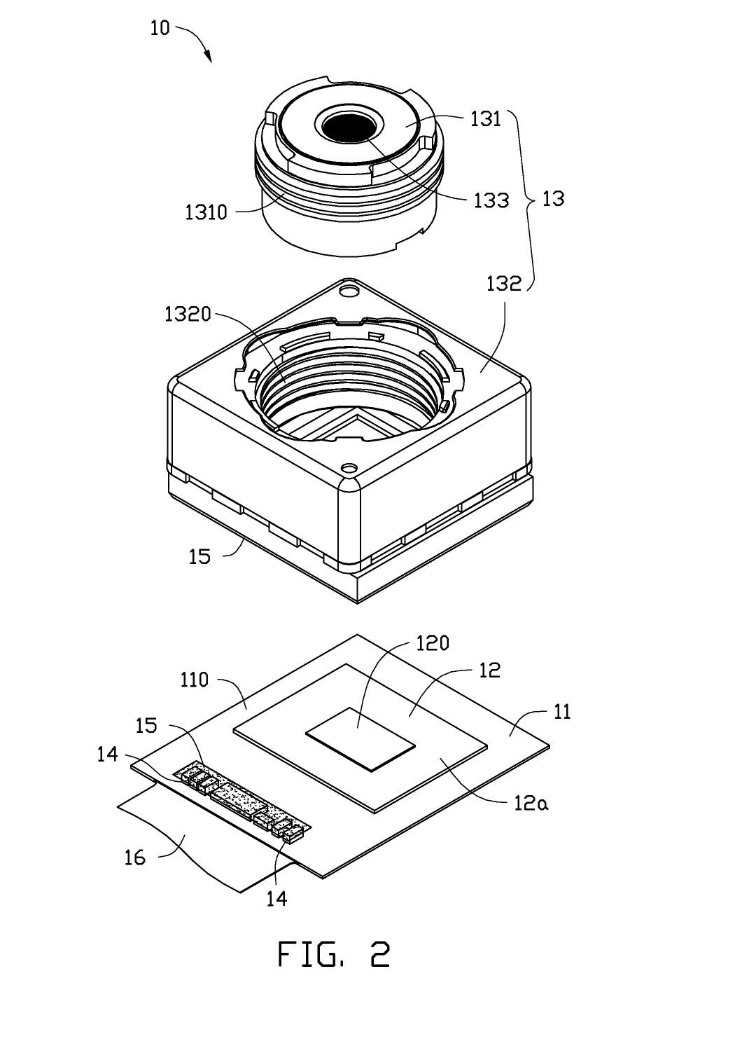

FIGS. 1-2 show a camera module 10, according to an embodiment. The camera module 10 includes a substrate 11, an image sensor chip 12, a lens module 13, a number of passive components 14, a colloid layer 15, and a flexible circuit board 16.

The substrate 11 can be made of a material such as: polyimide, ceramic, or glass. The substrate 11 has a supporting surface 110.

The image sensor chip 12 can be a charged coupled device (CCD) or a complementary metal-oxide-semiconductor (CMOS). The image sensor chip 12 includes a photosensitive area 120 formed on a top surface 12a of the image sensor chip 12. In the embodiment, the image sensor chip 12 is supported on the supporting surface 110, and mechanically and electrically connected to the substrate 11 by package processes, such as chip-scale, wafer-level chip-scale, ceramic leaded, plastic leadless chip, thermal compression bonding, or flip chip packaging processes. The image sensor chip 12 converts light signals received from the lens module 13 into digital electrical signals.

The lens module 13 is also positioned on the supporting surface 110 and aligned with the image sensor chip 12. The lens module 13 includes a lens barrel 131, a lens holder 132, and a number of lenses 133 received in the lens barrel 131. The lens barrel 131 has external threads 1310 formed on an external wall of the lens barrel 131, the lens holder 132 has internal threads 1320 formed on an internal wall of the lens holder 132, therefore the lens barrel 131 is capable of being received in and engaged with the lens holder 132. The lens module 13 is positioned on the substrate 11 with the image sensor chip 12 being received in the lens holder 132. In the embodiment, the lens module 13 adheres to the supporting surface 110 via the colloid layer 15. The colloid layer 15 can be, for example, silicone, epoxy, acrylic, or polyamide.

The passive components 14 can be resistors, capacitors, and inductors. The passive components 14 are also positioned on the supporting surface 110 and are mechanically and electrically connected to the substrate 11, the passive components 14 are located outside the lens holder 132. In other words, the passive components 14 are adjacent to the lens holder 132 without being received in the lens holder 132, and the lens module 13 has no passive components 14 received therein. As such, this avoids problems of dust and small particles generated by the passive components 14, or by the installation process, from falling onto the image sensor chip 12. Accordingly, the image quality of the camera module 10 is improved.

In the embodiment, the number of the passive components 14 are all covered by the colloid layer 15 to protect the passive components 14 from external contamination.

The flexible circuit board 16 is electrically connected to the substrate 11, and configured to guide digital electrical signals from the image sensor chip 12 to an external electronic device (such as digital signal processor).

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A camera module, comprising:
a substrate comprising a supporting surface;
an image sensor chip supported by the supporting surface, and electrically connected to the substrate;
a lens module positioned on the supporting surface with the image sensor chip being received in the lens module; and
a plurality of passive components positioned on the supporting surface and mechanically and electrically connected to the substrate, all of the passive components located outside the lens module.

2. The camera module of claim 1, wherein the substrate is made of polyimide, ceramic, or glass.

3. The camera module of claim 1, wherein the image sensor chip is a charged coupled device (CCD) or a complementary metal-oxide-semiconductor (CMOS).

4. The camera module of claim 1, wherein the lens module comprises a lens barrel, a lens holder, and a plurality of lenses received in the lens barrel, and the lens barrel is received in the lens holder.

5. The camera module of claim 1, further comprising a colloid layer, wherein the passive components are all covered by the colloid layer.

6. The camera module of claim 5, wherein the colloid layer is made of silicone, epoxy, acrylic, or polyamide.

7. The camera module of claim 1, wherein the passive components are resistors, capacitors, or inductors.

8. The camera module of claim 1, further comprising a flexible circuit board, wherein the flexible circuit board is electrically connected to the substrate.
